(19) United States
(12) Patent Application Publication
(10) Pub. No.: US 2026/0356570 A1
(43) Pub. Date: Nov. 12, 2026

(54) VACUUM INSULATED BOTTLE

(71) Applicant: GUANGZHOU QINGKUAI INNOVATION TECHNOLOGY CO., LTD., GUANGZHOU (CN)

(72) Inventors: YIGONG WU, GUANGZHOU (CN); HUIHUANG XIE, GUANGZHOU (CN); HUIQI HE, GUANGZHOU (CN)

(21) Appl. No.: 19/403,105

(22) Filed: Nov. 27, 2025

(30) Foreign Application Priority Data
May 12, 2025 (CN) 202520932159.0

(51) Int. Cl. B65D 81/38; A47J 41/02; B65D 51/24

(52) U.S. Cl. CPC B65D 81/3881; A47J 41/028; B65D 51/242; B65D 81/3883

(57) ABSTRACT

A vacuum insulated bottle includes an inner bottle, an outer bottle, and thermal insulation components. The outer bottle defines a first accommodating cavity. The thermal insulation components and the inner bottle are detachably placed in the first accommodating cavity. The thermal insulation components are disposed on an outer surface of the inner bottle and wrap an outer peripheral side surface of the inner bottle, an upper end outer surface of the inner bottle, and a lower end outer surface of the inner bottle, so as to prevent the outer surface of the inner bottle from being exposed. When the thermal insulation components and the inner bottle are disposed in the first accommodation cavity, the thermal insulation components isolate an inner surface of the outer bottle from the outer surface of the inner bottle. Each of the thermal insulation components includes a storage cavity configured to store a cooling medium.

### TECHNICAL FIELD

The present disclosure relates to a technical field of container cleaning and a technical field of containers, and in particular to a vacuum insulated bottle.

### BACKGROUND

A vacuum insulated bottle is configured to store food and/or liquids and to realize thermal insulation of the food and/or liquids therein. The thermal insulation refers to maintaining the food and/or liquid at a cool or warm temperature relative to room temperature, which is generally understood to be between 10℃ and 35℃.

Taking the vacuum insulated bottle storing the liquid as an example for further illustration. The liquid may be drinking water, breast milk, and other liquids. Adding ice cubes to the vacuum insulated bottle may cool the liquid inside and keep the liquid at a cool temperature. However, using the ice cubes to cool the liquid in the vacuum insulated bottle has low cooling efficiency, and the thermal insulation time is limited.

### BRIEF DESCRIPTION OF DRAWINGS

FIG. 1 is a schematic diagram of a vacuum insulated bottle according to one embodiment of the present disclosure.

FIG. 2 is another schematic diagram of the vacuum insulated bottle according to one embodiment of the present disclosure.

FIG. 3 is another schematic diagram of the vacuum insulated bottle according to one embodiment of the present disclosure.

FIG. 4 is a cross-sectional schematic diagram of the vacuum insulated bottle according to one embodiment of the present disclosure.

FIG. 5 is another cross-sectional schematic diagram of the vacuum insulated bottle according to one embodiment of the present disclosure.

FIG. 6 is an exploded schematic diagram of the vacuum insulated bottle according to one embodiment of the present disclosure.

FIG. 7 is a cross-sectional schematic diagram of an inner bottle and two thermal insulation components of the vacuum insulated bottle according to one embodiment of the present disclosure.

FIG. 8 is a schematic diagram of the two thermal insulation components of the vacuum insulated bottle according to one embodiment of the present disclosure.

FIG. 9 is a cross-sectional schematic diagram of the two thermal insulation components of the vacuum insulated bottle according to one embodiment of the present disclosure.

FIG. 10 is a schematic diagram of a first thermal insulation component shown in a first state according to one embodiment of the present disclosure.

FIG. 11 is a schematic diagram of the first thermal insulation component shown in the first state according to one embodiment of the present disclosure.

FIG. 12 is a schematic diagram of the first thermal insulation component shown in the first state according to one embodiment of the present disclosure.

FIG. 13 is a cross-sectional schematic diagram of the first thermal insulation component of the vacuum insulated bottle according to one embodiment of the present disclosure.

FIG. 14 is a schematic diagram of the first thermal insulation component shown in a second state according to one embodiment of the present disclosure.

FIG. 15 is a schematic diagram of the first thermal insulation component according to another embodiment of the present disclosure.

FIG. 16 is another schematic diagram of the first thermal insulation component according to another embodiment of the present disclosure.

FIG. 17 is another schematic diagram of the first thermal insulation component according to another embodiment of the present disclosure.

FIG. 18 is another schematic diagram of the first thermal insulation component according to another embodiment of the present disclosure.

### DETAILED DESCRIPTION

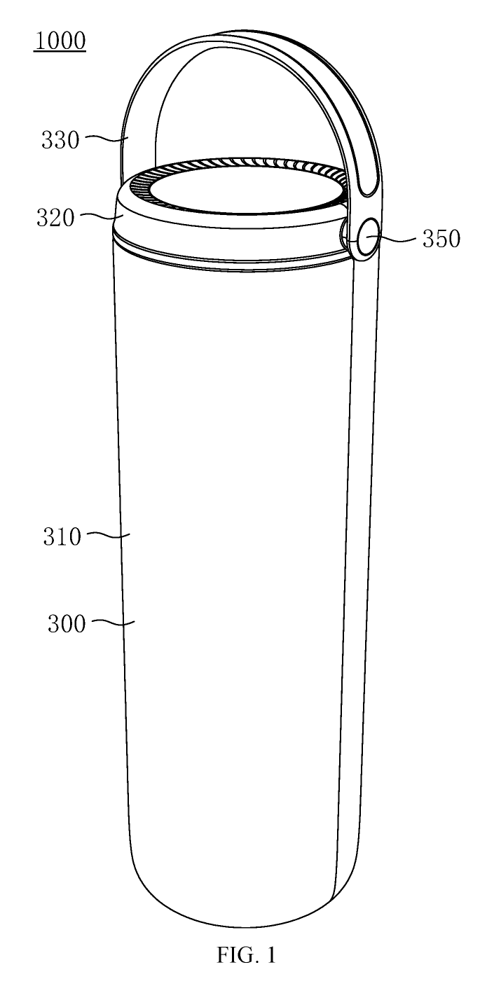

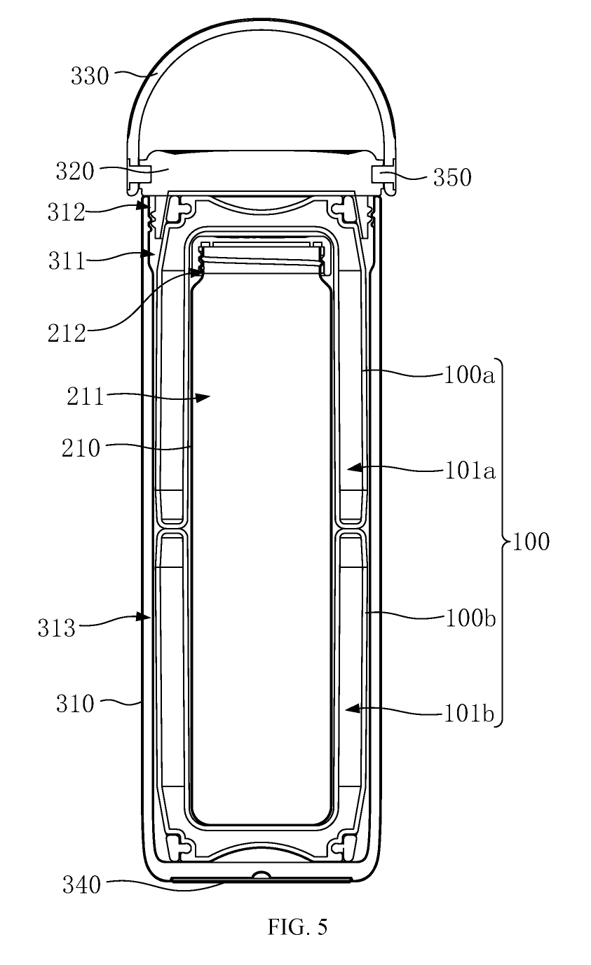

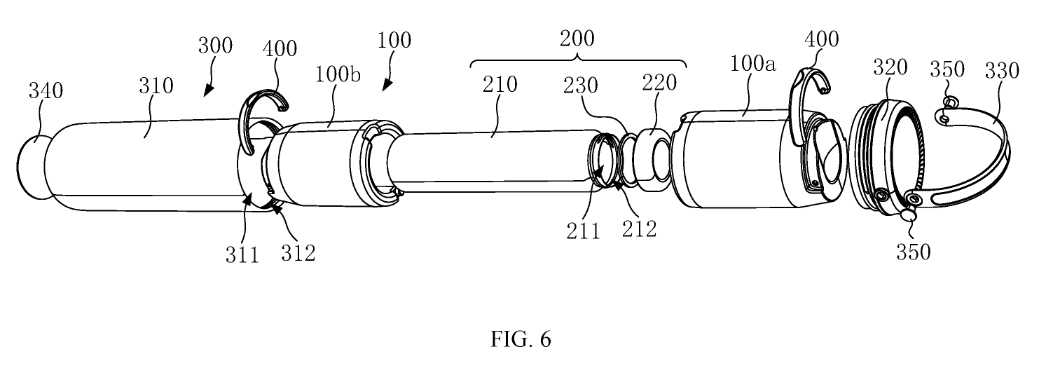

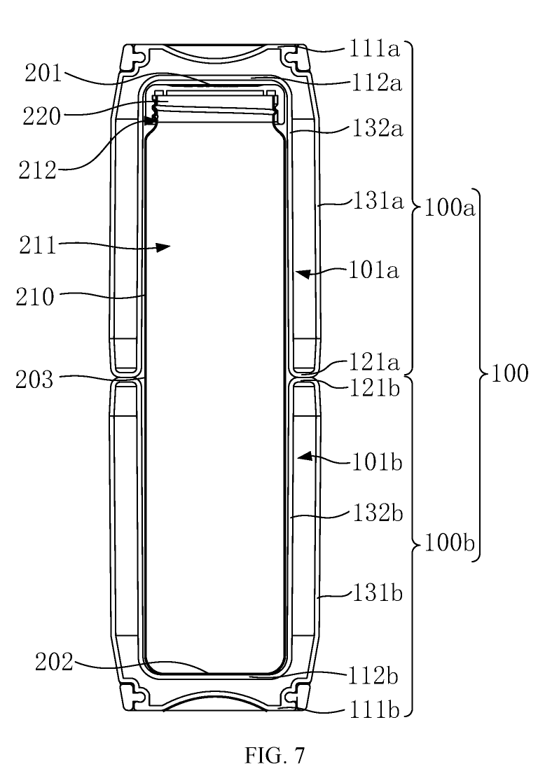

As shown in FIGS. 1-7, the present disclosure provides a vacuum insulated bottle 1000. The vacuum insulated bottle 1000 comprises an inner bottle 200 and thermal insulation components 100. The thermal insulation components 100 are disposed on an outer surface of the inner bottle 200, and the thermal insulation components 100 are capable of wrapping the outer peripheral side surface 203 of the inner bottle 200, an upper end outer surface 201 of the inner bottle 200, and an lower end outer surface 202 of the inner bottle 200, so as to prevent the outer surface of the inner bottle 200 from being exposed. Each of the thermal insulation components 100 comprises a receiving cavity configured to store a cooling medium. In the embodiment, the thermal insulation components 100 are able to wrap the entire outer surface of the inner bottle 200 to prevent the entire outer surface of the inner bottle 200 from being exposed, thereby effectively realizing thermal insulation on the inner bottle 200. When each cooling medium is added, the thermal insulation components 100 are able to quickly reduce a temperature of the inner bottle 200 and a temperature of the liquid or food stored inside the inner bottle 200, and are able to maintain the inner bottle 200 and the liquid or food stored inside the inner bottle 200 in a low-temperature environment for a long time.

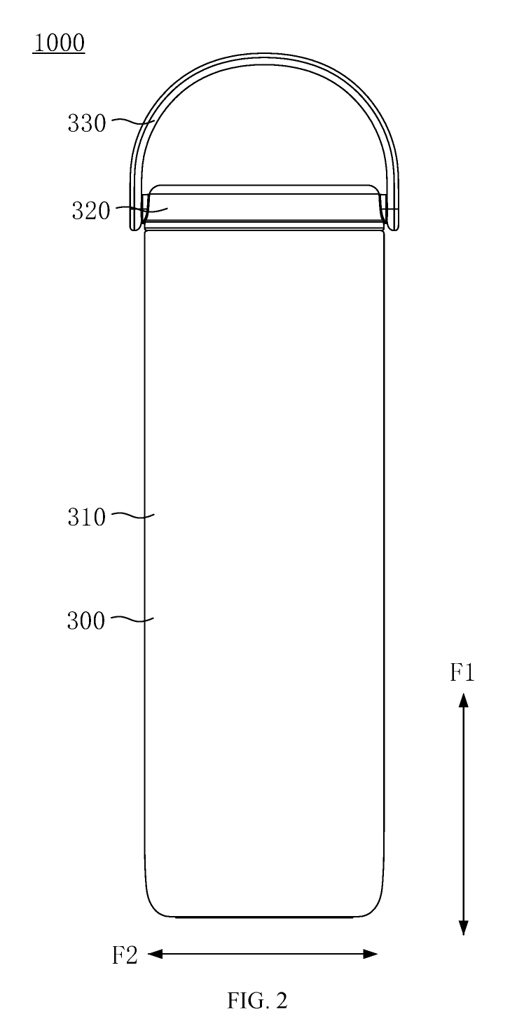

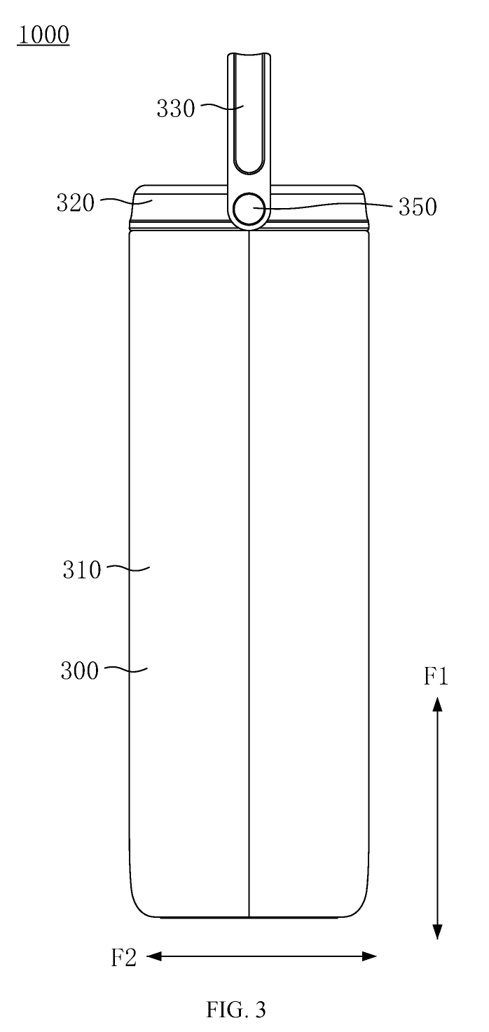

The outer peripheral side surface 203 connects the upper end outer surface 201 and the lower end outer surface 202 of the inner bottle 200. The upper end outer surface 201 is located at a first end of the outer peripheral side surface 203 of the inner bottle 200, and the lower end outer surface 202 is disposed at a second end of the outer peripheral side surface 203 of the inner bottle 200. That is, the upper end outer surface 201 and the lower end outer surface 202 of the inner bottle 200 are respectively located at two ends of the peripheral outer surface 203. As shown in FIGS. 2 and 3, the vacuum insulated bottle 1000 defines a first direction F1 and a second direction F2. The first direction F1 is understood as a height direction F1 of the vacuum insulated bottle 1000, where the second direction F2 is perpendicular to the first direction F1. The upper end outer surface 201 is located at a top portion of the inner bottle 200 in the first direction F1, the lower end outer surface 202 is located at a bottom portion of the inner bottle 200 in the first direction F1, and the outer peripheral side surface 203 is located between the upper end outer surface 201 and the lower end outer surface 202 of the inner bottle 200 in the first direction F1.

The inner bottle 200 comprises an inner bottle body 210 and an inner bottle lid 220. The inner bottle body 210 comprises a second accommodating cavity 211 and a second bottle opening 212 communicated with the second accommodating cavity 211. The second accommodating cavity 211 is configured to store liquid or food, such as breast milk. The liquids or food is able to be put into the second accommodating cavity 211 from the second bottle opening 212. The inner bottle lid 220 is configured to cover or open the second bottle opening 212. Optionally, the inner bottle lid 220 and the inner bottle body 210 are detachably connected, such as by a threaded connection.

Optionally, at least one sealing ring 230 is disposed in a connection position between the inner bottle lid 220 and the inner bottle body 210 to increase stability and sealing performance of a connection between the inner bottle lid 220 and the inner bottle body 210.

The second bottle opening 212 is located at a top portion of the inner bottle body 210 in the first direction F1. The upper end outer surface 201 of the inner bottle 200 is a top end outer surface of the inner bottle lid 220 in the first direction F1. The lower end outer surface 202 is a bottom end outer surface of the inner bottle body 210 in the first direction F1. The outer peripheral side surface 203 is peripheral outer surfaces of both the inner bottle body 210 and the inner bottle lid 220 in the first direction F1.

Optionally, the inner bottle body 210 is made of metal, such as stainless steel.

Optionally, the inner bottle lid 220 comprises a metal material and/or a non-metal material.

Optionally, as shown in FIGS. 1-6, the vacuum insulated bottle 1000 further comprises an outer bottle 300. The outer bottle 300 comprises an outer bottle body 310 and an outer bottle lid 320. The outer bottle body 310 comprises a first accommodating cavity 311 and a first bottle opening 312 communicated with the first accommodating cavity 311. The first accommodating cavity 311 is configured to accommodate the inner bottle 200 and the thermal insulation components 100. The inner bottle 200 and the thermal insulation components 100 are allowed to be placed in the first accommodating cavity 311 from the first bottle opening 312 and are allowed to be removed from the first accommodating cavity 311.

The outer bottle lid 320 is configured to cover the first bottle opening 312 and open the first bottle opening 312. The outer bottle lid 320 is detachably connected to the outer bottle body 310. For example, the outer bottle lid 320 is screwed with the outer bottle body 310. Optionally, at least one sealing ring is disposed at a connection position between the outer bottle lid 320 and the outer bottle body 310, so as to increase stability and sealing performance of the outer bottle lid 320 and the outer bottle body 310 in a connected state.

The first bottle opening 312 is located on a top end of the outer bottle body 310 in the first direction F1.

Optionally, the vacuum insulated bottle 1000 further comprises a handle 330 disposed on the outer bottle 300. The handle 330 is configured to be held by a user. Optionally, the handle 330 is disposed on the outer bottle lid 320. Optionally, the handle 330 is connected to the outer bottle lid 320 by two rotating shafts 350, and the handle 330 is rotatable relative to the outer bottle lid 320 around the rotating shafts 350.

Optionally, the thermos 1000 further comprises a gasket 340 disposed on the outer bottle body 310. The gasket 340 is disposed at a bottom end of the outer bottle body 310 in the first direction F1.

Optionally, the outer bottle body 310 is made of metal, such as stainless steel.

Optionally, the outer bottle lid 320 comprises a metallic material and/or a non-metallic material.

Optionally, the outer bottle body 310 is of a multi-layered structure, such as a double-layered structure. Optionally, the outer bottle body 31 defines a thermal insulation cavity 313 by the double-layered structure.

In the embodiment, when the thermal insulation components 100 and the inner bottle 200 are placed in the first accommodating cavity 311, the thermal insulation components 100 isolate an inner surface of the outer bottle 300 from an outer surface of the inner bottle 200.

The thermal insulation components 100 in the embodiment of the present disclosure are disposed on an outer side of the inner bottle 200 in the first direction F1 to wrap the outer surface of the inner bottle 200, and are exemplarily described below with reference to other drawings.

The thermal insulation components 100 comprise: a first thermal insulation component 100a and a second thermal insulation component 100b. The first thermal insulation component 100a is disposed on the outer peripheral side surface 203 of the inner bottle 200 and the upper end outer surface 201 of the inner bottle 200, so as to wrap the upper end outer surface 201 of the inner bottle 200 and a first portion of the outer peripheral side surface 203 of the inner bottle 200. The second thermal insulation component 100b is disposed on the outer peripheral side surface 203 and the lower end outer surface 202 of the inner bottle 200, so as to wrap the lower end outer surface 202 of the inner bottle 200 and a second portion of the outer peripheral side surface 203 of the inner bottle 200. When the first thermal insulation component 100a and the second thermal insulation component 100b are disposed on the outer surface of the inner bottle 200, an end surface of the first thermal insulation component 100a and an end surface of the second thermal insulation component 100b are attached to each other.

In one alternative embodiment, the thermal insulation components 100 comprise: the first thermal insulation component 100a and the second thermal insulation component 100b. The first thermal insulation component 100a is disposed on the outer peripheral side surface 203 of the inner bottle 200 and the upper end outer surface 201 of the inner bottle 200, so as to wrap the upper end outer surface 201 of the inner bottle 200 and the outer peripheral side surface 203 of the inner bottle 200. The second thermal insulation component 100b is disposed on the lower end outer surface 202 of the inner bottle 200, so as to wrap the lower end outer surface 202 of the inner bottle 200. When the first thermal insulation component 100a and the second thermal insulation component 100b are disposed on the outer surface of the inner bottle 200, an end surface of the first thermal insulation component 100a and an end surface of the second thermal insulation component 100b are attached to each other.

In one alternative embodiment, the thermal insulation components 100 comprise: the first thermal insulation component 100a and the second thermal insulation component 100b. The first thermal insulation component 100a is disposed on the upper end outer surface 201 of the inner bottle 200, so as to wrap the upper end outer surface 201 of the inner bottle 200. The second thermal insulation component 100b is disposed on the outer peripheral side surface 203 and the lower end outer surface 202 of the inner bottle 200, so as to wrap the lower end outer surface 202 of the inner bottle 200 and the outer peripheral side surface 203 of the inner bottle 200. When the first thermal insulation component 100a and the second thermal insulation component 100b are disposed on the outer surface of the inner bottle 200, an end surface of the first thermal insulation component 100a and an end surface of the second thermal insulation component 100b are attached to each other.

Optionally, the first thermal insulation component 100a is configured to be disposed on the outer peripheral side surface 203 of the inner bottle 200 and the upper end outer surface 201 of the inner bottle 200, so as to wrap the upper end outer surface 201 of the inner bottle 200 and a first portion of the outer peripheral side surface 203 of the inner bottle 200. The first thermal insulation component 100a comprises a first outer peripheral sidewall 131a, a first upper end wall 111a and a first lower end wall 121a. The first upper end wall 111a of the first thermal insulation component 100a is connected to an upper end of the first outer peripheral sidewall 131a of the first thermal insulation component 100a. The first lower end wall 121a of the first thermal insulation component 100a is connected to a lower end of the first outer peripheral sidewall 131a of the first thermal insulation component 100a, so that the first outer peripheral sidewall 131a, the first upper end wall 111a and the first lower end wall 121a of the first thermal insulation component 100a are enclosed to form a first storage cavity 101a. The first thermal insulation component 100a further comprises a first through hole 103a penetrating through the first lower end wall 121a. The first through hole 103a is communicated with the first storage cavity 101a; The second thermal insulation component 100b is configured to be disposed on the outer peripheral side surface 203 of the inner bottle 200 and the lower end outer surface 202 of the inner bottle 200, so as to wrap the lower end outer surface 202 of the inner bottle 200 and a second portion of the outer peripheral side surface 203 of the inner bottle 200. The second thermal insulation component 100b comprises a second outer peripheral sidewall 131b, a second upper end wall 111b and a second lower end wall 121b. The second upper end wall 111b of the second thermal insulation component 100b is connected to an upper end of the second outer peripheral sidewall 131b of the second thermal insulation component 100b. The second lower end wall 121b is connected to a lower end of the second outer peripheral sidewall 131b of the second thermal insulation component 100b, so that the second outer peripheral sidewall 131b, the second upper end wall 111b and the second lower end wall 121b of the second thermal insulation component 100b are enclosed to form a second storage cavity 101b. The second thermal insulation component 100b further comprises a second through hole 103b penetrating through the second lower end wall 121b of the second thermal insulation component 100b, and the second through hole 103b is communicated with the second storage cavity 101b.

When the first thermal insulation component 100a and the second thermal insulation component 100b are disposed on the outer surface of the inner bottle 200, the first lower end wall 121a of the first thermal insulation component 100a is attached to the second lower end wall 121b of the second thermal insulation component 100b.

The first thermal insulation component 100a further comprises a first inner end wall 112a and a first inner peripheral sidewall 132a. The first inner end wall 112a is connected to the first inner peripheral sidewall 132a. The first inner end wall 112a is disposed on a top end of the first inner peripheral sidewall 132a in the first direction F1. A bottom end of the second inner peripheral sidewall 132a is connected to the first lower end wall 121a in the first direction F1. Similarly, the second thermal insulation component 100a further comprises a second inner end wall 112b and a second inner peripheral sidewall 132b. The second inner end wall 112b is connected to the second inner peripheral sidewall 132b. The second inner end wall 112b is disposed on a top end of the second inner peripheral sidewall 132b in the first direction F1. A bottom end of the second inner peripheral sidewall 132b is connected to the second lower end wall 121b in the first direction F1. The first inner peripheral sidewall 132a and the first inner end wall 112a jointly define a first accommodating space 102a. The second inner end wall 112b and the second inner peripheral sidewall 132b jointly define a second accommodating space 102b. Both the first accommodating space 102a and the second accommodating space 102b are configured to jointly accommodate the inner bottle 200, so that the thermal insulation components 100 completely accommodate the inner bottle 200.

Optionally, the first through hole 103a faces the second through hole 103b.

The first thermal insulation component 100a further comprises a first groove 104a. The first outer peripheral sidewall 131a and the first lower end wall 121a of the first thermal insulation component 100a recess toward an interior of the first storage cavity 101a to form the first groove 104a. The first through hole 101a is communicated with the first groove 104a, which facilitates an input of cooling medium from the first groove 104a into the first storage cavity 101a. The first thermal insulation component 100a further comprises a first column 140a. The first column 140a is completely disposed in the first groove 104a, and the first column 140a does not exceed the first lower end wall 121a and the first outer peripheral sidewall 131a of the first thermal insulation component 100a; The first column 140a comprises a first channel 141a, and the first channel 141a is communicated with the first through hole 103a. The first thermal insulation component 100a further comprises a first sealing sleeve 500a. The first sealing sleeve 500a is sleeved on the first column 140a to close the first through hole 103a.

The second thermal insulation component 100b further comprises a second groove 104b. The second outer peripheral sidewall 131b and the second lower end wall 121b of the second thermal insulation component 100b recess toward an interior of the second storage cavity 101b to form the second groove 104b. The second through hole 101b is communicated with the second groove 104b, which facilitates an input of the cooling medium from the second groove 104b into the second storage cavity 101b. The second thermal insulation component 100b further comprises a second column 140b. The second column 140b is completely disposed in the second groove 104b, and the second column 140b does not exceed the second lower end wall 121b and the second outer peripheral sidewall 131b of the second thermal insulation component 100b. The second column 140b comprises a second channel 141b, and the second channel 141b is communicated with the second through hole 103b. The second thermal insulation component 100b further comprises a second sealing sleeve. The second sealing sleeve is sleeved on the second column 140b to close the second through hole 103b.

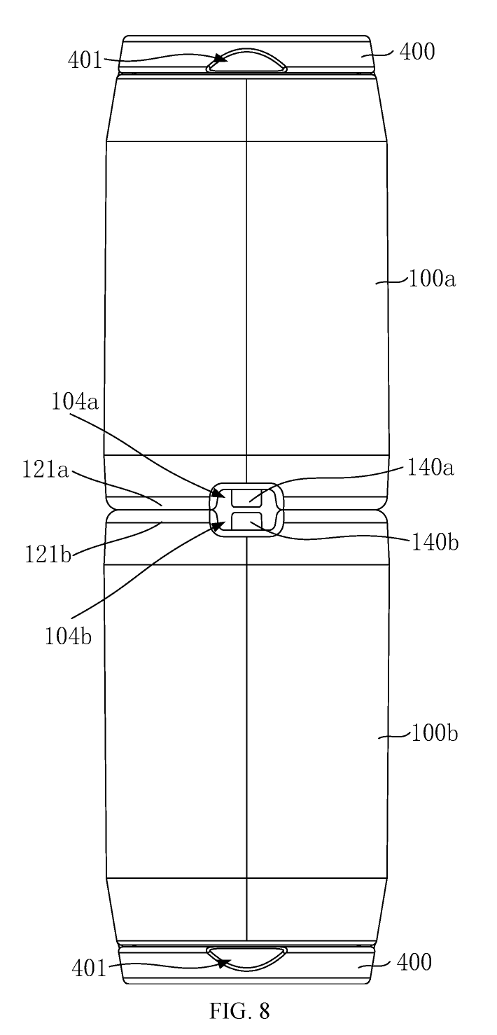

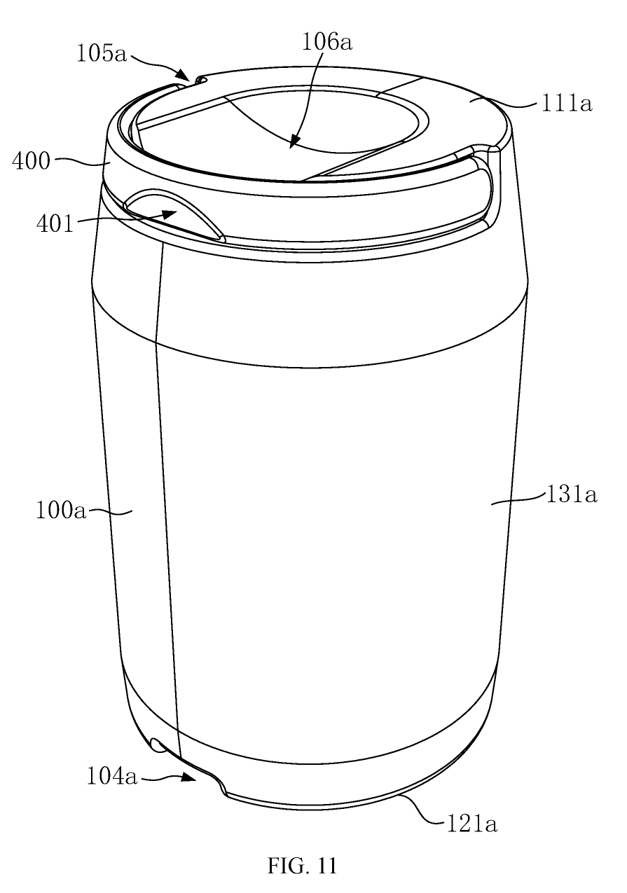

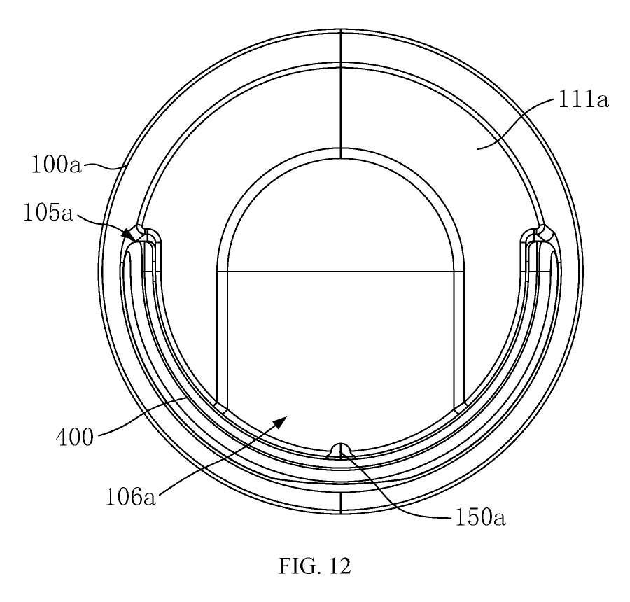

Optionally, as shown in FIGS. 1-14, only one first through hole 103a and one second through hole 103b are provided.

Optionally, the vacuum insulated bottle further comprises at least one detachable component 400. At least one of the thermal insulation components is connected to the at least one detachable component 400. For instance, only one detachable component 400 is provided and is connected to the first outer peripheral sidewall 131a of the first thermal insulation component 100a and is close to the first upper end wall 111a of the first thermal insulation component 100a.

Optionally, the first thermal insulation component 100a comprises a first receiving groove 105a. The first receiving groove 105a is formed at a junction of the first upper end wall 111a and the first outer peripheral sidewall 131a of the first thermal insulation component 100a. The detachable component 400 is rotatably connected to the first outer peripheral sidewall 131a of the first thermal insulation component 100a, and the detachable component 400 is rotatable relative to the first outer peripheral sidewall 131a, so that the detachable component 400 is allowed to be placed in the first receiving groove 105a or located above the first upper end wall 111a of the first thermal insulation component 100a. When the detachable component 400 is placed in the first receiving groove 105a, an outer surface of the detachable component 400 does not exceed an outer surface of the first outer peripheral sidewall 131a of the first thermal insulation component 100a.

Optionally, the first thermal insulation component 100a comprises a first recess 106a. The first recess 106a is formed on the first upper end wall 111a of the first thermal insulation component 100a. The first recess 106a is communicated with the first receiving groove 105a. When the detachable component 400 is placed in the first receiving groove 105a, a portion of the detachable component 400 is exposed at the first recess 106a, the user is able to drive the detachable component 400 at a position of the first recess 106a.

Optionally, a depth of the first recess 106a gradually increases along a direction of the first receiving groove 105a.

Optionally, the detachable component 400 defines a notch 401. The notch 401 is formed on the outer surface of the detachable component 400. When the detachable component 400 is placed in the first receiving groove 105a, the notch 401 is adjacent to the first outer peripheral sidewall 131a of the first thermal insulation component 100a.

Optionally, the first thermal insulation component 100a further comprises a first connecting structure 150a. The detachable component 400 comprises a second connecting structure 402, and the first connecting structure 150a is detachably connected to the second connecting structure 402. When the first connecting structure 150a and the second connecting structure 402 are connected to each other, the detachable component 400 is prevented from moving. When the first connecting structure 150a and the second connecting structure 402 are separated from each other, the detachable component 400 is movable relative to the first thermal insulation component 100a. When the detachable component 400 is placed in the first receiving groove 105a, the first connecting structure 150a and the second connecting structure 402 are connected to each other, so as to limit the detachable component 400 in the first receiving groove 105a without an external force.

Optionally, one of the first connecting structure 150a and the second connecting structure 402 is a snapping fastener, and the other one is a snapping groove. The snapping fastener is detachably snapped into the snapping groove. For example, the first connecting structure 150a is the snapping fastener, and the second connecting structure 402 is the snapping groove.

Optionally, the detachable component 400 is connected to the first thermal insulation component 100a via rotating shafts 410, and the detachable component 400 is rotatable relative to the first thermal insulation component 100a around the rotating shafts 410.

In one optional embodiment, a structure of the first thermal insulation component 100a is the same as a structure of the second thermal insulation component 100b. In the embodiment, the at least one detachable component comprises two detachable components respectively connected to the first thermal insulation component 100a and the second thermal insulation component 100b. The first thermal insulation component 100a is connected to a first detachable component 400. The second thermal insulation component 100b is connected to a second detachable component 400. The second detachable component 400 is connected to the second thermal insulation component 100b via corresponding rotating shafts 410. The second detachable component 400 is rotatable relative to the second thermal insulation component 100b around the corresponding rotating shafts 410. In the embodiment, the second thermal insulation component 100b defines a second receiving groove, which may be referenced to the first receiving groove 105a. In the embodiment, the second thermal insulation component 100b defines a second recess, which may be referenced to the first recess 106a. In the embodiment, the second thermal insulation component 100b further comprises a corresponding first connecting structure, which may be referenced to the first connecting structure 150a.

In other embodiments, the structure of the first thermal insulation component 100a is different from the structure of the second thermal insulation component 100b.

An assembling process of placing the thermal insulation components 100 and the inner bottle 200 inside the outer bottle 300 is as follows.

Step 011 comprises placing a liquid, such as breast milk, in the inner bottle body 210 of the inner bottle 200, and covering the inner bottle lid 220 on the inner bottle body 210.

Step 012 comprises sleeving the first thermal insulation component 100a and the second thermal insulation component 100b on the outer surface of the inner bottle 200 so as to cover the outer surface of the inner bottle 200. For instance, the second thermal insulation component 100b is sleeved on the lower end of the inner bottle 200, and then the first thermal insulation component 100a is sleeved on the upper end of the inner bottle 200, and adjacent walls of the first thermal insulation component 100a and the second thermal insulation component 200a are attached to each other, that is, the first lower end wall 121a is attached to the second lower end wall 121b. It should be noted that when the inner bottle 200 needs to be cooled, or a temperature of the inner bottle 200 needs to be kept cold, the cooling medium, such as a pre-stored cooling liquid, such as water or a gel, is pre-stored in the first thermal insulation component 100a and the second thermal insulation component 100b. Then, the first thermal insulation component 100a and the second thermal insulation component 100b are pre-frozen. After the first thermal insulation component 100a and the second thermal insulation component 100b are sleeved on the inner bottle 200, rapid cooling of the inner bottle 200 and the breast milk contained in the inner bottle 200 is realized. For example, the inner bottle 200 and the breast milk therein are cooled from room temperature to below 4°C within a predetermined time. The predetermined time is, for example, 2 minutes, 3 minutes, 5 minutes, 6 minutes, etc. It should be noted that the cooling medium is not limited to a cooling liquid, and may be a variable-phase material, such as paraffin, capable of prolonging the cooling time.

Step 013 comprises putting the first thermal insulation component 100a, the second thermal insulation component 100b, and the inner bottle 200 wrapped by the first thermal insulation component 100a and the second thermal insulation component 100b together into the first accommodating cavity 311 of the outer bottle body 310 of the outer bottle 300, and covering the outer bottle lid 320 on the outer bottle body 310.

The thermal insulation components 100 in the embodiments of the present disclosure are able to effectively cool the inner bottle 200 and effectively maintain the temperature of the liquid in the inner bottle 200. In addition, in some embodiments of the present disclosure, the outer bottle body 310 is of the double-layer structure to form the thermal insulation cavity 313, which further reduces the emission of cold or heat, thereby achieving the effect of long-acting thermal insulation. In some cases, the thermal insulation cavity 313 is a vacuum cavity.

It should be noted that, in the embodiment of the present disclosure, the bottle body 210 is made of metal, such as the stainless steel, which quickly transmit cold and realizes the rapid cooling of the liquid therein.

In some cases, the outer bottle body 310 is made of a double-layer vacuum thermal insulation material to isolate external heat intrusion. The thermal insulation components 100 are closely attached to the inner bottle 200, and the thermal insulation components 100 completely wrap the inner bottle 200 to form a cooling environment with uniform cooling capacity. The vacuum insulated bottle has a function similar to that of a small cooling box, and a size of the vacuum insulated bottle 1000 is configured according to requirements, and the vacuum insulated bottle is able to be applied to an outgoing scene of a mother and infant group.

A process of taking out the thermal insulation components 100 and the inner bottle 200 from the outer bottle 300 is as follows.

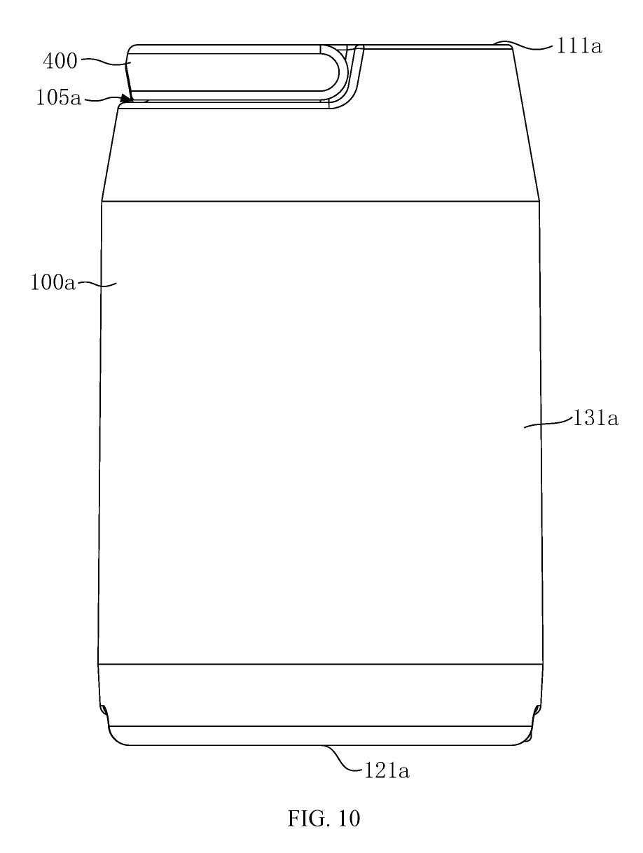

Step 021 comprises driving the outer bottle lid 320, and removing the outer bottle lid 320 from the outer bottle body 310 so as to open the first bottle opening 312 of the outer bottle body 310. At this time, the first detachable component 400 is located in the first accommodating cavity 311 and close to the first bottle opening 312, and the first detachable component 400 is placed into the first receiving groove 105a in the first thermal insulation component 100a or is placed in the second receiving groove in the second thermal insulation component 100b. In the step, the first thermal insulation component 100a is closer to the first bottle opening 312 than the second thermal insulation component 100b by default, that is, the first detachable component 400 close to the first bottle opening 312 is placed in the first receiving groove 105a. As shown in FIGS. 10-12 where the first thermal insulation component 100a is in a first state, the first detachable component 400 is located in the first receiving groove 105a.

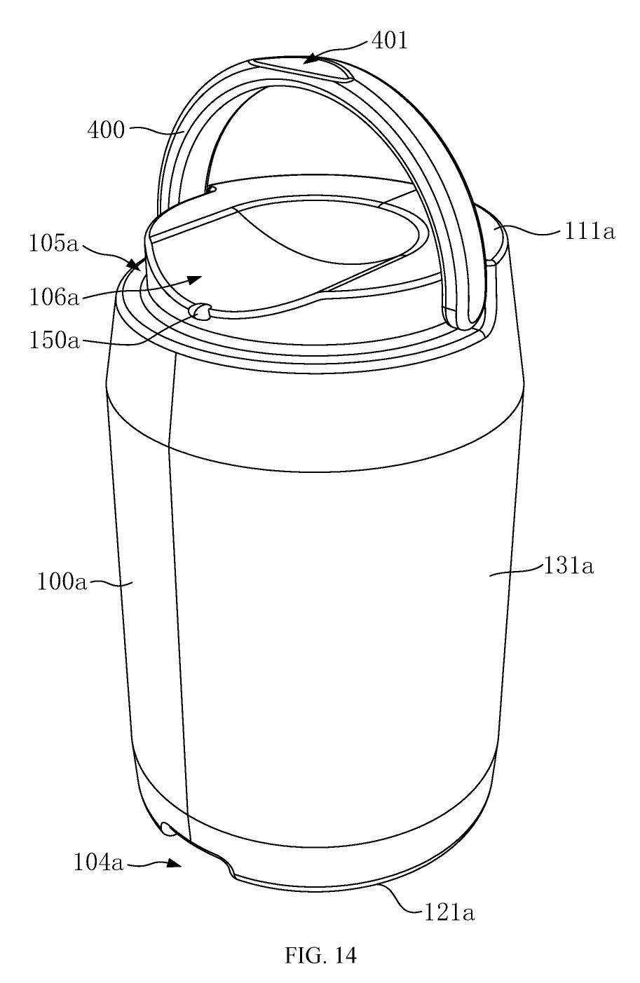

Step 022 comprises applying a force, by a finger of the user or a tool on the first recess 106a of the first thermal insulation component 100a to the first detachable component 400, and then applying a force to drive both the first connecting structure 150a and the second connecting structure 402 from a connection state to a separation state, and continuously applying a force to rotate the first detachable component 400 to a position where the first detachable component 400 is allowed to be removed from the first bottle opening 312. At this time, the first thermal insulation component 100 shown in FIG. 14 is in a second state, and the first detachable component 400 is disposed above the first upper end wall 111a.

Step 023 comprises pulling the first detachable component 400, by the finger or the tool, and taking out the first thermal insulation component 100a from the first accommodating cavity 311.

Step 024 comprises directly flipping the outer bottle body 310, by the user, to pour out the inner bottle 200 and the second thermal insulation member 100b according to gravity.

In other alternative embodiments, the thermal insulation components are sleeved on the outer surface of the inner bottle 200 along the second direction F2, thus covering the outer surface of the inner bottle 200.

It should be noted that the method of removing the thermal insulation components 100 from the outer bottle 300 is not limited to providing the at least one detachable component 400 on the thermal insulation components 100. The following description, in conjunction with other accompanying drawings, provides an alternative explanation.

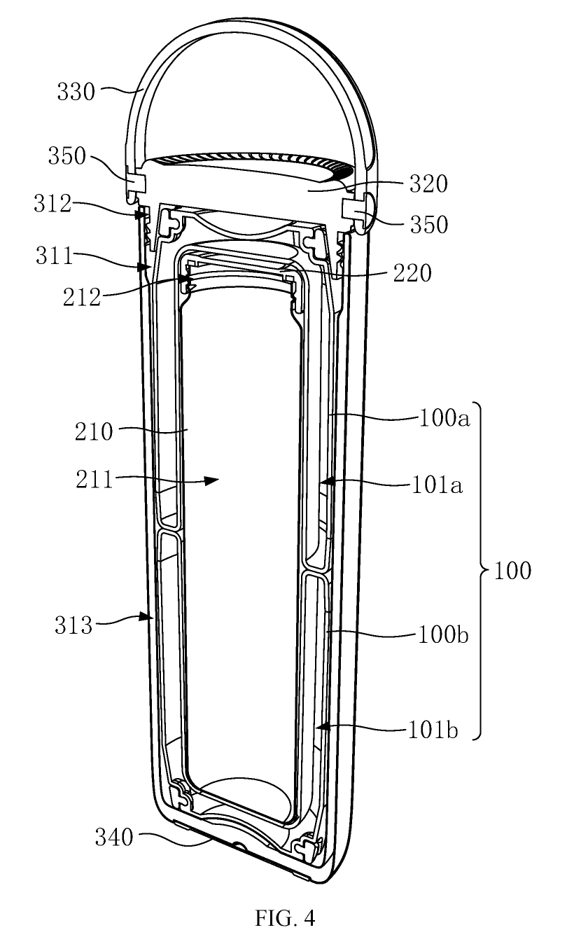

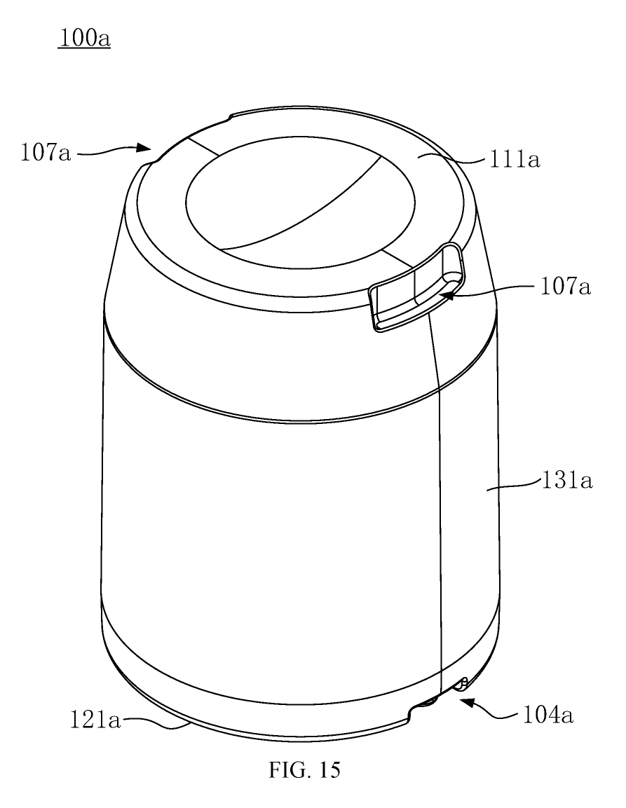

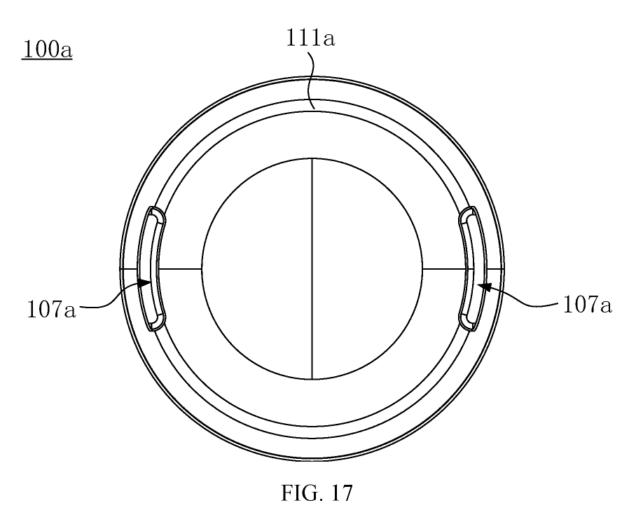

As shown in FIGS. 15-18, a difference between the first thermal insulation component 100a shown in FIGS. 15-17 and the first thermal insulation component 100a shown in FIGS. 4-14 is that the first thermal insulation component 100 shown in FIGS. 15-17 further comprises first notch structures 107a. The first notch structures 107a are spaced apart from each other. The first notch structures 107a are formed at a junction of the first upper end wall 111a and the first outer peripheral sidewall 131a of the first thermal insulation component 100a; or the first notch structures 107a are formed on the first upper end wall 111a of the first thermal insulation component 100a. For instance, the first notch structures comprise two first notch structures 107a. The two first notch structures 107a are spaced apart, for example, positioned opposite each other. Thus, when the user needs to remove the first thermal insulation component 100a, the tool or the finger applies the force to positions of the two first notch structures 107a, thereby applying force to the wall forming the two first notch structures 107a. In this way, the first thermal insulation component 100a is removed from the first accommodating cavity 311 of the outer bottle body 310.

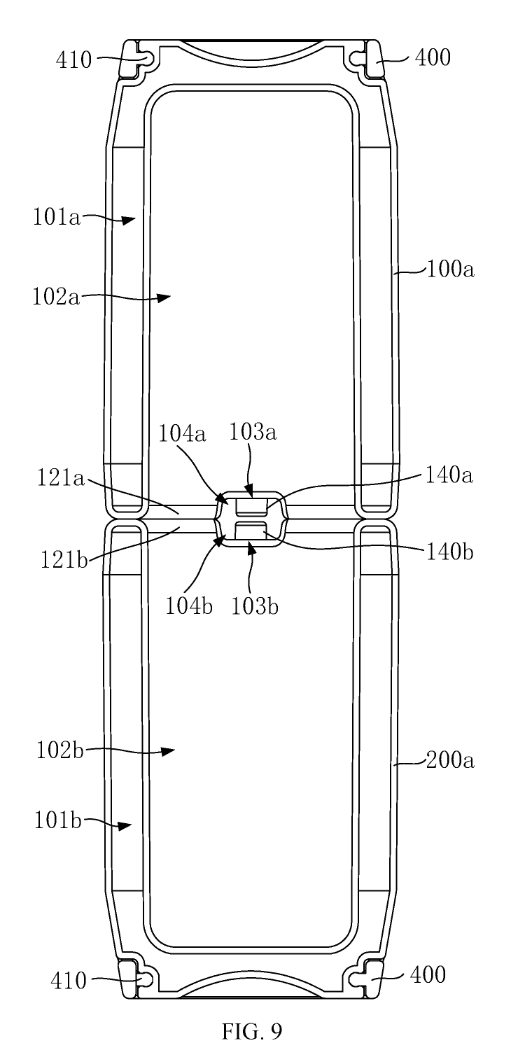

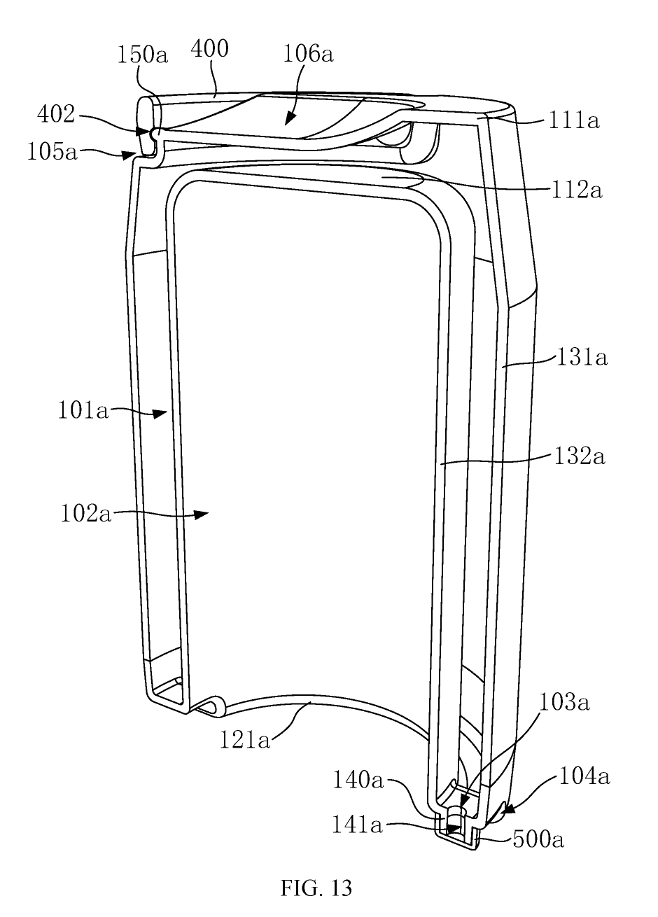

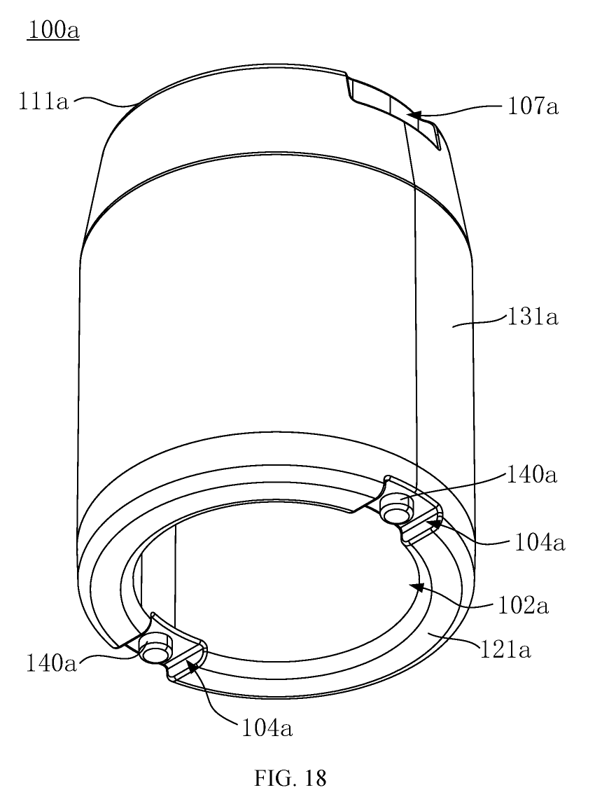

Other structures of the first thermal insulation component 100a shown in FIGS. 15-17 may refer to the first thermal insulation component 100a shown in FIGS. 4-14. For example, the first accommodating space 102a of the first thermal insulation component 100a shown in FIG. 18 may refer to the first accommodating space 102a of the first thermal insulation component 100a shown in FIGS. 9 and 13, which is not described in detail herein.

As shown in FIGS. 1-9, it should be noted that the second thermal insulation component 100b further comprises second notch structures. The second notch structures are formed at a junction between the second upper end wall 111b and the second outer peripheral sidewall 131b of the second thermal insulation component 100b. Alternatively, two second notch structures are formed on the second upper end wall 111b of the second thermal insulation component 100b. The two second notch structures may be referenced to the first notch structures 107a, which are not described in detail herein.

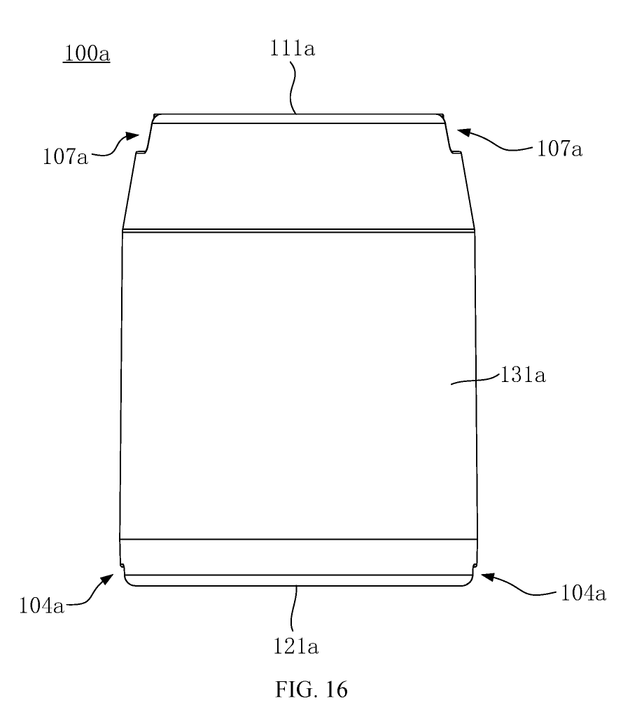

Optionally, a difference between the thermal insulation component 100 shown in FIGS. 16 and 18 and the thermal insulation component 100 shown in FIGS. 4-14 is that the thermal insulation components 100 shown in FIGS. 16 and 18 comprise at least two first through holes 103a and/or at least two second through holes 103b. For example, there are two first through holes 103a and two second through holes 103b, with the two first through holes 103a and the two second through holes 103b disposed opposite each other. When there are at least two first through holes 103a and at least two through holes 103b, there are also at least two first grooves 104a, at least two second grooves 104b, at least two first columns140a and at least two second columns 140b. Furthermore, referring to FIG. 13, when two first columns are provided, there are two first sealing sleeves 500a, and when two second columns are provided, there are two second sealing sleeves, there are also at least two first closing sleeves 500a and two closing sleeves.

What is claimed is:

1. A vacuum insulated bottle, comprising:
an inner bottle;
an outer bottle; and
thermal insulation components;
wherein the outer bottle defines a first accommodating cavity, and the thermal insulation components and the inner bottle are allowed to be placed in or removed from the first accommodating cavity;
wherein the thermal insulation components are disposed on an outer surface of the inner bottle, and the thermal insulation components are capable of wrapping an outer peripheral side surface of the inner bottle, an upper end outer surface of the inner bottle, and a lower end outer surface of the inner bottle, so as to prevent the outer surface of the inner bottle from being exposed;
wherein when the thermal insulation components and the inner bottle are disposed in the first accommodation cavity, the thermal insulation components isolate an inner surface of the outer bottle from the outer surface of the inner bottle;
wherein each of the thermal insulation components comprises a storage cavity configured to store a cooling medium.

2. The vacuum insulated bottle according to claim 1, wherein the thermal insulation components comprise a first thermal insulation component and a second thermal insulation component;
wherein the first thermal insulation component is disposed on the outer peripheral side surface of the inner bottle and the upper end outer surface of the inner bottle, so as to wrap the upper end outer surface of the inner bottle and a first portion of the outer peripheral side surface of the inner bottle;
wherein the second thermal insulation component is disposed on the outer peripheral side surface and the lower end outer surface of the inner bottle, so as to wrap the lower end outer surface of the inner bottle and a second portion of the outer peripheral side surface of the inner bottle;
wherein when the first thermal insulation component and the second thermal insulation component are disposed on the outer surface of the inner bottle, an end surface of the first thermal insulation component and an end surface of the second thermal insulation component are attached to each other.

3. The vacuum insulated bottle according to claim 1, wherein the thermal insulation components comprise a first thermal insulation component and a second thermal insulation component;
wherein the first thermal insulation component is disposed on the outer peripheral side surface of the inner bottle and the upper end outer surface of the inner bottle, so as to wrap the upper end outer surface of the inner bottle and the outer peripheral side surface of the inner bottle;
wherein the second thermal insulation component is disposed on the lower end outer surface of the inner bottle, so as to wrap the lower end outer surface of the inner bottle;
wherein when the first thermal insulation component and the second thermal insulation component are disposed on the outer surface of the inner bottle, an end surface of the first thermal insulation component and an end surface of the second thermal insulation component are attached to each other.

4. The vacuum insulated bottle according to claim 1, wherein the thermal insulation components comprise a first thermal insulation component and a second thermal insulation component;
wherein the first thermal insulation component is disposed on the upper end outer surface of the inner bottle, so as to wrap the upper end outer surface of the inner bottle;
wherein the second thermal insulation component is disposed on the outer peripheral side surface and the lower end outer surface of the inner bottle, so as to wrap the lower end outer surface of the inner bottle and the outer peripheral side surface of the inner bottle;
wherein when the first thermal insulation component and the second thermal insulation component are disposed on the outer surface of the inner bottle, an end surface of the first thermal insulation component and an end surface of the second thermal insulation component are attached to each other.

5. The vacuum insulated bottle according to claim 1, wherein when the first thermal insulation component and the second thermal insulation component are disposed on the outer surface of the inner bottle, an end surface of the first thermal insulation component and an end surface of the second thermal insulation component are attached to each other.

6. The vacuum insulated bottle according to claim 1, wherein the thermal insulation components comprise a first thermal insulation component and a second thermal insulation component;
wherein the first thermal insulation component is configured to be disposed on the outer peripheral side surface of the inner bottle and the upper end outer surface of the inner bottle, so as to wrap the upper end outer surface of the inner bottle and a first portion of the outer peripheral side surface of the inner bottle;
wherein the first thermal insulation component comprises a first outer peripheral sidewall, a first upper end wall and a first lower end wall;
wherein the first upper end wall of the first thermal insulation component is connected to an upper end of the first outer peripheral sidewall of the first thermal insulation component, and the first lower end wall of the first thermal insulation component is connected to a lower end of the first outer peripheral sidewall of the first thermal insulation component, so that the first outer peripheral sidewall, the first upper end wall and the first lower end wall of the first thermal insulation component are enclosed to form a first storage cavity;
wherein the first thermal insulation component further comprises at least one first through hole penetrating through the first lower end wall, and the at least one first through hole thereof is communicated with the first storage cavity;
wherein the second thermal insulation component is configured to be disposed on the outer peripheral side surface of the inner bottle and the lower end outer surface of the inner bottle, so as to wrap the lower end outer surface of the inner bottle and a second portion of the outer peripheral side surface of the inner bottle;
wherein the second thermal insulation component comprises a second outer peripheral sidewall, a second upper end wall and a second lower end wall;
wherein the second upper end wall of the second thermal insulation component is connected to an upper end of the second outer peripheral sidewall of the second thermal insulation component, and the second lower end wall is connected to a lower end of the second outer peripheral sidewall of the second thermal insulation component, so that the second outer peripheral sidewall, the second upper end wall and the second lower end wall of the second thermal insulation component are enclosed to form a second storage cavity;
wherein the second thermal insulation component further comprises at least one second through hole penetrating through the second lower end wall of the second thermal insulation component, and the at least one second through hole is communicated with the second storage cavity;
wherein when the first thermal insulation component and the second thermal insulation component are disposed on the outer surface of the inner bottle, the first lower end wall of the first thermal insulation component is attached to the second lower end wall of the second thermal insulation component.

7. The vacuum insulated bottle according to claim 6, wherein the at least one first through hole faces the at least one second through hole.

8. The vacuum insulated bottle according to claim 1, wherein the thermal insulation components comprise a first thermal insulation component;
wherein the first thermal insulation component comprises a first outer peripheral sidewall, a first upper end wall, and a first lower end wall;
wherein the first upper end wall is connected to an upper end of the first outer peripheral sidewall of the first thermal insulation component, and the first lower end wall is connected to a lower end of the first outer peripheral sidewall of the first thermal insulation component, so that the first outer peripheral sidewall, the first upper end wall and the first lower end wall of the first thermal insulation component are enclosed to form a first storage cavity;
wherein the first thermal insulation component further comprises at least one first through hole, at least one first groove, at least one first column, and at least one first sealing sleeve;
wherein the at least one first through hole penetrates through the first lower end wall of the first thermal insulation component, the at least one first through hole is communicated with the first storage cavity, the first outer peripheral sidewall and the first lower end wall of the first thermal insulation component recess toward an interior of the first storage cavity to form the at least one first groove, the at least one first column is completely disposed in the at least one first groove, and the at least one first column does not exceed the first lower end wall and the first outer peripheral sidewall of the first thermal insulation component;
wherein the at least one first column comprises a first channel, and the first channel is communicated with the at least one first through hole;
wherein the at least one first sealing sleeve is sleeved on the at least one first column to close the at least one first through hole.

9. The vacuum insulated bottle according to claim 1, wherein the thermal insulation components comprise a first thermal insulation component and a second thermal insulation component, and a structure of the first thermal insulation component is the same as a structure of the second thermal insulation component.

10. The vacuum insulated bottle according to claim 1, wherein the thermal insulation components comprise a first thermal insulation component;
wherein the first thermal insulation component comprises a first outer peripheral sidewall, a first upper end wall and a first lower end wall;
wherein the first upper end wall thereof is connected to an upper end of the first outer peripheral sidewall thereof, and the first lower end wall is connected to a lower end of the first outer peripheral sidewall thereof;
wherein the vacuum insulated bottle further comprises a detachable component, the detachable component is connected to the first outer peripheral sidewall of the first thermal insulation component and is close to the first upper end wall of the first thermal insulation component.

11. The vacuum insulated bottle according to claim 10, wherein the first thermal insulation component comprises a first receiving groove, and the first receiving groove is formed at a junction of the first upper end wall and the first outer peripheral sidewall of the first thermal insulation component;
wherein the detachable component is rotatably connected to the first outer peripheral sidewall of the first thermal insulation component, and the detachable component is rotatable relative to the first outer peripheral sidewall, so that the component is allowed to be placed in the first receiving groove or located above the first upper end wall of the first thermal insulation component;
wherein when the detachable component is placed in the first receiving groove, an outer surface of the at least one detachable component does not exceed an outer surface of the first outer peripheral sidewall of the first thermal insulation component.

12. The vacuum insulated bottle according to claim 11, wherein the first thermal insulation component comprises a first recess, the first recess is formed on the first upper end wall of the first thermal insulation component, and the first recess is communicated with the first receiving groove;
wherein when the detachable component is placed in the first receiving groove, a portion of the detachable component is exposed at the first recess, and a depth of the first recess gradually increases along a direction of the first receiving groove; and/or
the detachable component defines a notch, the notch is formed on the outer surface of the detachable component, and when the detachable component is placed in the first receiving groove, the notch is adjacent to the first outer peripheral sidewall of the first thermal insulation component.

13. The vacuum insulated bottle according to claim 11, wherein the first thermal insulation component further comprises a first connecting structure, the detachable component comprises a second connecting structure, and the first connecting structure is detachably connected to the second connecting structure;
wherein when the first connecting structure and the second connecting structure are connected to each other, the detachable component is prevented from moving, and when the first connecting structure and the second connecting structure are separated from each other, the detachable component is movable relative to the first thermal insulation component;
wherein when the detachable component is placed in the first receiving groove, the first connecting structure and the second connecting structure are connected to each other, so as to limit the detachable component in the first receiving groove without an external force.

14. The vacuum insulated bottle according to claim 1, wherein the thermal insulation components comprise a first thermal insulation component;
wherein the first thermal insulation component comprises a first outer peripheral sidewall, a first upper end wall and a first lower end wall; wherein the first upper end wall thereof is connected to an upper end of the first outer peripheral sidewall thereof, and the first lower end wall is connected to a lower end of the first outer peripheral sidewall thereof;
wherein the first thermal insulation component further comprises first notch structures, the first notch structures are spaced apart from each other, and the first notch structures are formed at a junction of the first upper end wall and the first outer peripheral sidewall of the first thermal insulation component, or the first notch structures are formed on the first upper end wall of the first thermal insulation component.

15. The vacuum insulated bottle according to claim 1, wherein the outer bottle comprises an outer bottle body and an outer bottle lid, the outer bottle body comprises the first accommodating cavity and a first bottle opening communicated with the first accommodating cavity;
wherein the outer bottle lid is configured to cover or open the first bottle opening, and the thermal insulation components and the inner bottle are allowed to be placed in the first accommodating cavity from the first bottle opening.

16. The vacuum insulated bottle according to claim 15, wherein the outer bottle is of a double-layer structure to define a thermal insulation cavity.

17. The vacuum insulated bottle according to claim 15, wherein the outer bottle body is made of metal.

18. The vacuum insulated bottle according to claim 1, wherein the inner bottle comprises an inner bottle body and an inner bottle lid;
wherein the inner bottle body comprises a second accommodating cavity and a second bottle opening communicated with the second accommodating cavity, the inner bottle lid is configured to cover or open the second bottle opening, and the inner bottle body is made of metal.
